(19) United States
(12) Patent Application Publication
(10) Pub. No.: US 2005/0243284 A1
(43) Pub. Date: Nov. 3, 2005

(54) Projection apparatus with light sources having common prism exit optical path

(76) Inventor: David E. Slobodin, Lake Oswego, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/835,683

(22) Filed: Apr. 30, 2004

(51) Int. Cl. G03B 21/00

(52) U.S. Cl. 353/33

(57) ABSTRACT

A projection apparatus is formed employing a prism and a plurality of light sources. The latter are employed to output a plurality of different color light bundles of different wavelengths for the prism. The light sources and the prism are disposed relative to each other in a manner such that the different color light bundles of different wavelengths enter the prism at angles suitable for the respective wavelengths and the prism, for the different color light bundles of different wavelengths to exit the prism on a substantially common optical path.

### BACKGROUND

Historically, projection engines of projection systems have been designed employing high intensity discharge lamps. These prior art projection engines/systems suffer from a number of disadvantages. For examples, the lamps typically have relatively short lives, and reduced brightness after an initial period of usage. Further, there is an appreciable period of waiting for the lamp to warm up, when a projection engine/system is first turned on. During that period, either no image is available or the available images are of poor quality. Additionally, active cooling arrangements are typically required to dissipate the heat created during operation.

Resultantly, there has been a lot of interest in developing and manufacturing in a mass scale projection engines and projection systems employing solid state light sources. Such engines/systems typically either do not have the aforementioned disadvantages or have the aforementioned disadvantages to a lesser degree.

FIG. 1 illustrates a simplified plane view of a typical solid state light source and micro mirror light valve based projection system architecture. The plane view may be a top view or a side view of the projection system. As illustrated, solid state light source based projection system 100 includes a number of primary color solid state light sources, such as LEDs 102-106 sourcing red (R), green (G) and blue (B) lights respectively. LEDs 102-106 are arranged in an orthogonal manner, respectively disposed on 3 sides of dichroic combiner 108. Dichroic combiner 108 is employed to combine the light emitted by LEDs 102-106. Further, light integrator 110 is placed in the light path to enhance the combined light. Mirror 112 is employed to reflect the enhanced light onto micro mirror device 114. In various implementations, one or more relay lens (not shown) may also be employed to focus light from the integrator rod 110 onto micro mirror device 114

Micro mirror device 114 includes a number of micro-mirrors that may be individually tilted to an “on” or an “off” position to selectively reflect the enhanced light reflected from mirror 112 towards projection lens 116 (“on”) or away from projection lens 116 (“off”). Resultantly, with each micro mirror corresponding to a pixel, and by selectively controlling their positions or the length of time the mirror pixel is in the “on” state, an image or a series of images, including a series of images forming a motion picture, may be projected.

While the architecture of FIG. 1 works well, it is nevertheless desirable to further improve on reducing the cost and/or increasing reliability of the next generation of projection engines and projection systems.

### BRIEF DESCRIPTION OF THE DRAWINGS

Embodiments of the present invention will be described by way of the accompanying drawings in which like references denote similar elements, and in which:

FIG. 1 illustrates a simplified plane view of a typical prior art solid state light source based projection engine/system;

FIG. 2 illustrates a block diagram view of a projection system in accordance with one embodiment of the present invention;

FIG. 3 illustrates a plane view of the relative disposition between the light sources and the prism in accordance with one embodiment; and

FIGS. 4a-4b illustrate two plane views of the other optical components in accordance with two embodiments.

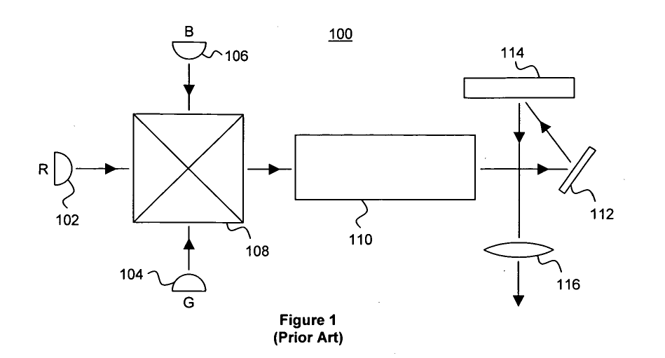

### DETAILED DESCRIPTION OF EMBODIMENTS OF THE INVENTION

Embodiments of the present invention include but are not limited to projection engines and projection systems having lights sources and a prism with particular relative disposition.

In the following description, various aspects of embodiments of the present invention will be described. However, it will be apparent to those skilled in the art that other embodiments may be practiced with only some or all of the described aspects. For purposes of explanation, specific numbers, materials and configurations are set forth in order to provide a thorough understanding of the embodiments. However, it will be apparent to one skilled in the art that other embodiments may be practiced without the specific details. In other instances, well-known features are omitted or simplified in order not to obscure the description.

Various operations will be described as multiple discrete operations in turn, in a manner that is most helpful in understanding the embodiments, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

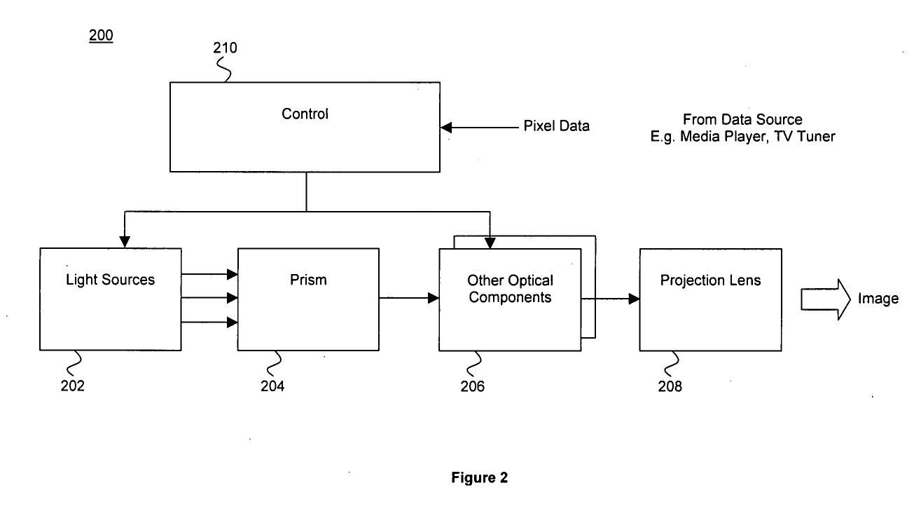

Referring first to FIG. 2 wherein a block diagram view of a projection system 200 for projecting images, in accordance with one embodiment of the present invention, is illustrated. As illustrated, for the embodiment, projection system 200 includes light sources 202, prism 204, a number of other optical components 206 and projection lens 208, optically coupled to each other as shown. In various embodiments, other optical components 206 include in particular, a light valve (not explicitly shown). Additionally, for the embodiment, projection system 200 includes control block 210 electrically coupled to light sources 202 and at least the light valve of the other optical components 206.

Light sources 202 are employed to provide a number of primary color light bundles. In various embodiments, the primary color light bundles comprise a red, a blue and a green light bundle. In alternate embodiments, other primary color light bundles may be provided instead.

In various embodiments, light sources 202 comprise solid state light sources. More specifically, in some embodiments, light sources 202 comprise light emitting diodes (LED), whereas in other embodiments, light sources 202 comprise laser diodes.

Prism 204 is employed to direct the primary color light bundles onto a common optical path towards other optical components 206. As will be described more fully below, the primary color light bundles are directed onto the common optical path through advantageous relative disposition between light sources 202 and prism 204. Resultantly, projection system 200 may be formed more cost effectively, without the need to employ the more expensive dichroic combiner. As will be readily apparent from the description to follow, a wide range of prisms may be employed to implement prism 204.

Other optical components 206 (in particular, the light valve) are primarily employed to selectively direct the primary color light bundles to projection lens 208. Optionally, other optical components 206 may also include components such as integrator rods and so forth to enhance the uniformity, brightness, and/or other optical attributes of the primary color light bundles. Similar to prism 204, a wide range of light valves and integrator rods may be employed to implement these elements.

Projection lens 208 projects the focused primary color light bundles onto a surface. Likewise, a wide range of projection lens may be employed to implement projection lens 208.

Control block 210 is employed to control light sources 202 and at least the light valve of other optical components 206, to project images based on the pixel data of the images received. In some embodiments, the pixel data may be provided e.g. from an external computing/media device or an integrated TV tuner (through e.g. an input interface). In various embodiments, control block 210 includes drive circuitry (not shown) to apply an amount of voltage or current to drive light sources 202. In various embodiments, control block 210 causes the primary color light sources 202 to be driven sequentially. In various embodiments, control block 210 may be implemented employing a general purpose processor/controller, an application specific integrated circuit (ASIC), or a programmable logic device (PLD).

In various embodiments, projection system 200 is a projector. In other embodiments, projection system 200 is a projection television.

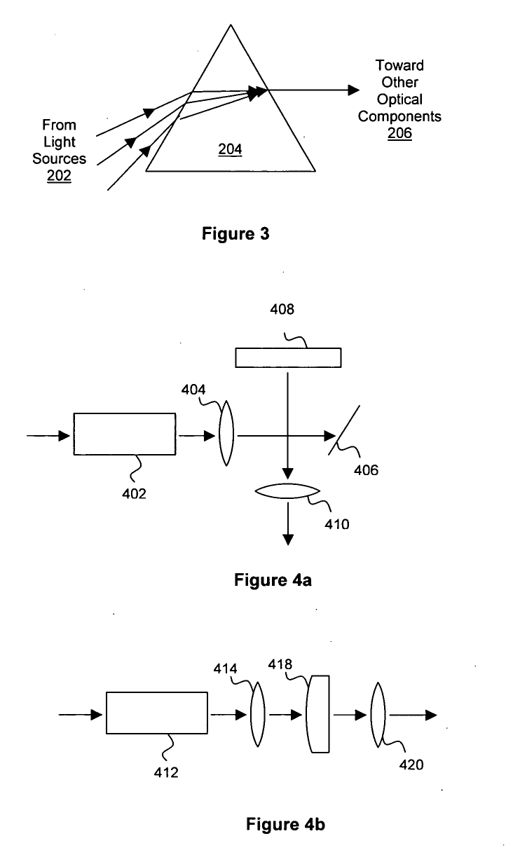

FIG. 3 illustrates a plane view of the relative disposition between light sources 202 and prism 204 in accordance with one embodiment. As earlier described, prism 204 is employed to direct the primary color light bundles onto a common optical path towards other optical components. More specifically, the various light sources 202 are angularly disposed relative to prism 204, such that the corresponding light bundles enter prism 204 with the appropriate angles for the light bundles and the prism, resulting in the light bundles to exit substantially on the same optical path.

The exact relative angles are application dependent, i.e. dependent on the primary color of a light bundle, more specifically, its wavelength (which is different for different colors), and the refraction index of the prism (which is different for different colors). For a selected prism having a particular optical dispersion (as measured for example by Abbe number), the appropriate relatively disposition for a light source outputting a primary color of a particular wavelength may be empirically determined or computed based on known optical behaviors/relationships, e.g. Snell's law of refraction. In various implementations, a prism composed of material with low Abbe number or high dispersion is desired to enable higher angular separation (and therefore physical separation) between the primary color light, e.g. red, green, and blue light. (For example a prism made of Hoya E-FDS1 glass with an Abbe number of 20.88 enables ˜5 degrees of separation between red and green and green and blue light sources, respectively.)

FIGS. 4a-4b illustrate two plane views of other optical components 206 in accordance with two embodiments. For the embodiment of FIG. 4a, other components 206 include light valve 408, which is a reflective light valve, whereas for the embodiment of FIG. 4b, other components 206 include light valve 418, which is a transmissive light valve.

Further, other components 206 of both embodiments include integrator rods 402 and 412 respectively, to enhance at least the uniformity and brightness of the primary color light bundles.

For the embodiment of FIG. 4a, other components 206 further include lens 404 and mirror 406, optically coupled to each other, and the earlier described reflective light valve 408 and integrator rod 402 as shown.

For the embodiment of FIG. 4b, other components 206 further include lens 414 optically coupled to the earlier described transmissive light valve 418 and integrator rod 412 as shown.

In other embodiments, as described earlier, the invention may be practiced without integrator rod 402/412.

Thus, it can be seen from the above description, a projection system having light sources and a prism having particular relative disposition have been described. While the present invention has been described in terms of the foregoing embodiments, those skilled in the art will recognize that the invention is not limited to the embodiments described. Other embodiments may be practiced with modification and alteration within the spirit and scope of the appended claims. Accordingly, the description is to be regarded as illustrative instead of restrictive.

1. A projection engine comprising:
a prism; and
a plurality of light sources to output a plurality of different color light bundles of different wavelengths towards the prism, with the light sources and the prism being disposed relative to each other in a manner such that the different color light bundles of different wavelengths enter the prism at angles suitable for their respective wavelengths and the prism, for the different color light bundles of different wavelengths to exit the prism on a substantially common optical path.

2. The projection engine of claim 1, wherein the light sources are primary color light sources comprising at least two of a red color light source, a blue color light source, and a green color light source.

3. The projection engine of claim 1, wherein the light sources comprise at least one solid state light source.

4. The projection engine of claim 3, wherein the at least one solid state light source comprises at least a selected one of a light emitting diode and a laser diode.

5. A projection system comprising:
a projection lens;
a prism optically coupled to the projection lens; and
a plurality of light sources to output a plurality of different color light bundles of different wavelengths towards the prism, with the light sources and the prism being disposed relative to each other in a manner such that the different color light bundles of different wavelengths enter the prism at angles suitable for their respective wavelengths and the prism, for the different color light bundles of different wavelengths to exit the prism on a substantially common optical path.

6. The projection system of claim 5, wherein the plurality of light sources comprise at least two of a red color light source, a blue color light source, and a green color light source.

7. The projection system of claim 5, wherein the plurality of light sources comprise at least one solid state light source.

8. The projection system of claim 7, wherein the at least one solid state light source comprises at least a selected one of a light emitting diode and a laser diode.

9. The projection system of claim 5, wherein the projection system further comprises a light tunnel optically coupled to the prism to facilitate coupling light bundles exiting the prism to the projection lens.

10. The projection system of claim 9, wherein the projection system further comprises a light valve optically coupled to the light tunnel to couple light bundles exiting the light tunnel to the projection lens.

11. The projection system of claim 5, wherein the projection system further comprises
a processor coupled to the light sources to control the light sources to project an image; and
an input interface unit coupled to the processor to facilitate input to the processor pixel data of the image.

12. The projection system of claim 11, wherein the projection system further comprises a television tuner coupled to the input interface unit.

13. In a projection apparatus, a method of operation comprising:
receiving pixel data of an image to be projected;
controlling a plurality of light sources to emit different color light bundles of different wavelengths towards a prism, the light sources and the prism being disposed relative to each other in a manner such that the different color light bundles of different wavelengths enter the prism at angles suitable for their respective wavelengths and the prism, for the different color light bundles of different wavelengths to exit the prism on a substantially common optical path.

14. The method of claim 13, wherein said controlling comprises controlling the light sources to alternate in emitting the different color light bundles at different points in time as needed for the projection of the image.

15. The method of claim 14, wherein the method further comprises controlling a light valve in a complementary manner.
